(19) United States
(12) Patent Application Publication
(10) Pub. No.: US 2013/0200709 A1
(43) Pub. Date: Aug. 8, 2013

(54) Techniques for Grid Coupling Photovoltaic Cells Using Ratiometric Voltage Conversion

(71) Applicants: Peter Daniel Kirchner, Putnam Valley, NY (US); Dennis G. Manzer, Bedford Hills, NY (US); Yves C. Martin, Ossining, NY (US); Thomas Picunko, Scarsdale, NY (US); Robert L. Sandstrom, Chestnut Ridge, NY (US); Theodore Gerard van Kessel, Millbrook, NY (US)

(72) Inventors: Peter Daniel Kirchner, Putnam Valley, NY (US); Dennis G. Manzer, Bedford Hills, NY (US); Yves C. Martin, Ossining, NY (US); Thomas Picunko, Scarsdale, NY (US); Robert L. Sandstrom, Chestnut Ridge, NY (US); Theodore Gerard van Kessel, Millbrook, NY (US)

(73) Assignee: International Business Machines Corporation, Armonk, NY (US)

(21) Appl. No.: 13/365,699

(22) Filed: Feb. 3, 2012

(51) Int. Cl. H02J 1/00

(52) U.S. Cl. 307/77; 307/82

(57) ABSTRACT

Techniques for electrical power transfer in photovoltaic systems are provided. In one aspect, a photovoltaic system includes an array of photovoltaic power producing elements (e.g., concentrator photovoltaic cells); a power receiving unit; and at least one ratiometric DC to DC converter connected to both the array of photovoltaic power producing elements and the power receiving unit. The array of photovoltaic power producing elements can include a plurality of the photovoltaic power producing elements connected in series or in parallel. In another aspect, a method of transferring electrical power from an array of photovoltaic power producing elements to a power receiving unit includes the following step. At least one ratiometric DC to DC converter is connected to both the array of photovoltaic power producing elements and the power receiving unit. The at least one ratiometric DC to DC converter is configured to alter a voltage output from the array.

### FIELD OF THE INVENTION

The present invention relates to photovoltaic power systems and more particularly, to concentrator photovoltaic power systems.

### BACKGROUND OF THE INVENTION

Solar photovoltaic power systems electrically connect multiple photovoltaic cells to the power grid. In a typical system this is achieved by serially connecting individual cells to produce high DC voltage and low current. Arrays of these serially connected cells are subsequently connected in serial and parallel topographies to produce strings operating at approximately 600 V peak.

Series connected cells are, however, performance limited by the weakest cell(s) in the string. In a series connected circuit, the current through all cells is the same. Cells that are operating at a current other than the maximum power point will thus be limited to less than optimal performance. This limitation increases in severity with concentration. In the case of parallel connected cells, the current produced is large and the voltage too low to be useful for most applications. Also, producing large current is costly in terms of resistive losses and the amount of conductor necessary to connect the system. Also, regardless of the connection scheme, it is common that the cells are mismatched with regard to current and/or voltage relative to the device(s) to which the power is being supplied.

Therefore, techniques for maximizing performance from a grid connected array of photovoltaic cells, and/or being able to match application-specific current voltage ratio requirements would be desirable.

### SUMMARY OF THE INVENTION

The present invention provides techniques for electrical power transfer in photovoltaic systems. In one aspect of the invention, a photovoltaic system is provided. The photovoltaic system includes an array of photovoltaic power producing elements; a power receiving unit; and at least one ratiometric DC to DC converter connected to both the array of photovoltaic power producing elements and the power receiving unit. The at least one ratiometric DC to DC converter is configured to alter a voltage output from the array of photovoltaic power producing elements supplied to the power receiving unit. The photovoltaic power producing elements can include concentrator photovoltaic cells. The power receiving unit may include a grid tied commercial power inverter or micro inverter. The power receiving unit can include a maximum power point tracker (MPPT) circuit and a grid tied DC to AC inverter connected to the maximum power point tracker (MPPT) circuit. The power receiving unit may include a DC to DC converter or may simply be a device that consumes DC power.

The array of photovoltaic power producing elements can include a plurality of the photovoltaic power producing elements connected in series. Alternatively, the array of photovoltaic power producing elements can include a plurality of the photovoltaic power producing elements connected in parallel. In the present context a single photovoltaic power producing element may include one or more (e.g., a grouping of) photovoltaic cells connected in serial or parallel.

In another aspect of the invention, a method of transferring electrical power from an array of photovoltaic power producing elements to a power receiving unit is provided. The method includes the following step. At least one ratiometric DC to DC converter is connected to both the array of photovoltaic power producing elements and the power receiving unit. The at least one ratiometric DC to DC converter is configured to alter a voltage output from the array of photovoltaic power producing elements supplied to the power receiving unit.

A more complete understanding of the present invention, as well as further features and advantages of the present invention, will be obtained by reference to the following detailed description and drawings.

### BRIEF DESCRIPTION OF THE DRAWINGS

FIG. 1 is a circuit diagram of a photovoltaic system having an array of photovoltaic power producing elements that is connected in series to the input of a ratiometric DC to DC converter according to an embodiment of the present invention;

FIG. 2 is a circuit diagram of a photovoltaic system wherein an array of photovoltaic power producing elements is connected in parallel to the input of a ratiometric DC to DC converter according to an embodiment of the present invention;

FIG. 3 is a circuit diagram of a photovoltaic system wherein an array of photovoltaic power producing elements is directly connected to the input of ratiometric DC to DC converters in a one to one relationship according to an embodiment of the present invention;

FIG. 4 is a circuit diagram of a photovoltaic system wherein an array of photovoltaic power producing elements is connected in series to a power receiving unit and the output of each of the series connected photovoltaic power producing elements is further connected to the inputs of ratiometric DC to DC converters in a one to one relationship (the outputs of the ratiometric DC to DC converters are constrained by parallel connection to a common voltage and allowed to float thereby constraining the inputs to a common voltage) according to an embodiment of the present invention;

FIG. 5 is a circuit diagram of a photovoltaic system wherein an array of photovoltaic power producing elements is connected to a power receiving unit wherein the photovoltaic elements are grouped in parallel clusters of four and the individual clusters are further connected in series according to an embodiment of the present invention;

FIG. 6 is a diagram illustrating an exemplary methodology for transferring electrical power from an array of photovoltaic power producing elements to a power receiving unit according to an embodiment of the present invention; and

FIG. 7 is a graph that illustrates the power output versus voltage performance for two photovoltaic elements according to an embodiment of the present invention.

### DETAILED DESCRIPTION OF PREFERRED EMBODIMENTS

Provided herein are techniques for connection of photovoltaic power producing elements, such as photovoltaic cells, to power conditioning and grid tie circuitry. With concentrator photovoltaic cells in particular, these systems are characterized by significantly higher cell currents and increasingly larger distances between cells. In some applications individual cell currents can reach 30 amps per square centimeter of cell area. At these current levels, connectors become expensive and very thick wires are required to connect cells. Thus, maximizing performance from a grid connected array of photovoltaic power producing elements is important, especially in the case of concentrator photovoltaic systems.

The circuits described herein utilize a ratiometric DC to DC converter. In general, a DC to DC converter is a type of power converter circuit that can convert a source of direct current (DC) from one voltage level to another. In particular, a ratiometric DC to DC converter is defined as a circuit that imposes a fixed voltage ratio between its input and output. Power may flow in either a forward or reverse direction through the ratiometric DC to DC converter. Finally, the input and output are electrically isolated. An example of this type of circuit is the VTM48EH040T025A00 made by Vicor Corporation, Andover Mass.

As will be apparent from the following description, some of the following benefits provided through use of the present techniques are as follows: first, the present techniques permit the optimization of individual cell performance. Namely, as will be described in detail below, some embodiments described are configured to allow each photovoltaic power producing element (e.g., photovoltaic cell) or group of elements to operate at its maximum performance level. By comparison, with conventional systems, the overall performance of the system is typically limited by the maximum performance of the weakest cell.

Second, as will be described in detail below, the present techniques permit the voltage produced by an array of photovoltaic cells to be increased (boosted)/decreased (bucked) based on the requirements of the power receiving unit.

Third, the ability to vary (increase/decrease) the voltage output from the array of photovoltaic cells (e.g., by way of a ratiometric DC to DC converter, see below) as according to the present techniques preserves the ability to operate maximum power point tracking (MPPT) systems. Maximum power point tracking (MPPT) systems operate by varying the input impedance of the power receiving unit and observing the current variation until the optimum power point is identified (and thereafter operating at that point) and thereby allowing the photovoltaic cells to operate at the most efficient voltage for optimum power transfer. With conventional (non ratiometric) DC to DC converters which output a fixed voltage an MPPT cannot be used because the output voltage is constrained to a constant value. MPPT systems will be described in detail below.

Fourth, the present techniques may be used to reduce the total amount of copper used for interconnects (higher currents require more copper to avoid resistive losses). By enabling the array of power producing elements to produce power at a higher voltage, the current that would otherwise be produced is reduced. In some concentrator elements current output can reach 30 A. Higher currents naturally require more copper in the various connections to avoid resistive losses. Thus, by reducing the current output, the amount of copper employed in the present systems can overall be reduced. This can mean a significant savings in terms of cost of materials, weight, etc.

It is noted that all of the connections shown in the figures and described herein may be formed using conventional electrical wiring. By way of example only, the term electrical wiring includes any type of insulated conductor that can be used to carry electricity. Examples of suitable electrical wiring include, but are not limited to insulated copper wires.

In conventional systems, arrays of individual photovoltaic cells are generally connected either in series or in parallel to a device(s) to which power is being supplied. Connecting the photovoltaic cells in series has the advantage that the photovoltaic cells produce a large voltage that is proportional to the number of cells in the series. This allows for less series resistance power losses. However, the photovoltaic cells are current limited by the weakest cells in the series. In small arrays, optical misalignment of a cell or a poor quality cell can strongly impact the performance of the series. In larger systems, shadowing (i.e., shading caused by neighboring structures, clouds . . . ) will have a degrading effect on the series. By contrast, connecting the photovoltaic cells in parallel has the advantage that the photovoltaic cells are not current limited by the weakest cell (since the cells are connected in parallel). A parallel connection has the further advantage that current can be monitored for individual cells using hall effect sensors and used as a direct measure of cell performance including optical alignment. However, conventional parallel-connected photovoltaic cell systems produce high current (e.g., 2 to 20 amps from a single cell) and thus are challenging to implement in practice.

As highlighted above, the present techniques relate generally to the coupling of power from photovoltaic cells to MPPT and inverter systems. The following discussion will focus on the use of a micro inverter (i.e., the low power (e.g., from about 100 watts to about 500 watts) version of a combined MPPT/DC to AC inverter) with the understanding that the techniques presented are equally applicable to higher power (e.g., 50,000 watts or more) commercial inverter units.

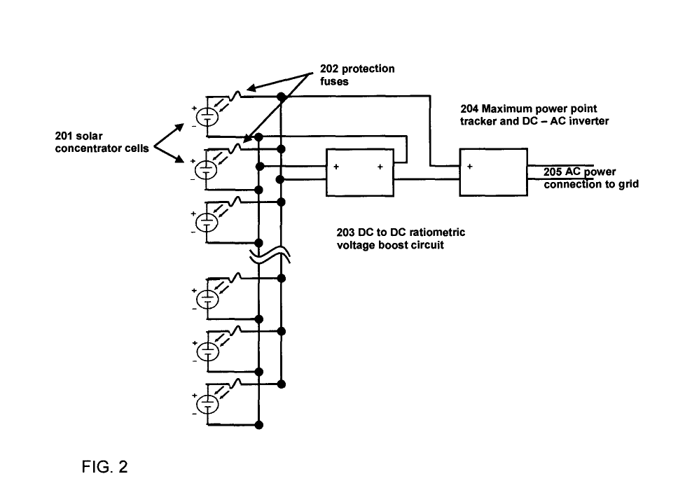

Further, concentrator photovoltaic systems operating at very high concentration may require optical alignment of individual receivers to achieve optimal power performance. Cells are most easily aligned by monitoring short circuit current or individual cell current at the maximum power point. This is challenging for serially connected cells. Thus, connecting the power producing elements in parallel (as shown in FIG. 2) may be advantageous if monitoring short circuit current or individual cell current at the maximum power point is desired.

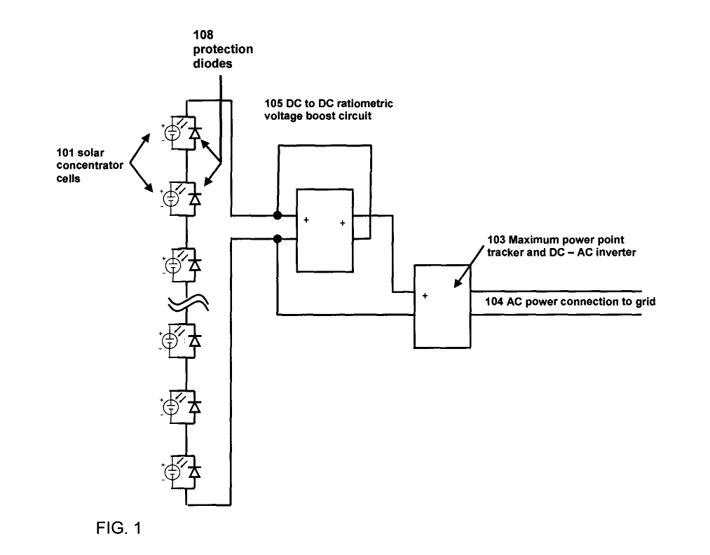

FIG. 1 is a circuit diagram of a photovoltaic system wherein a series of photovoltaic power producing elements 101 such as photovoltaic cells (e.g., concentrator photovoltaic cells), are connected (with protection diodes 108 in parallel) in series with a ratiometric DC to DC converter 105 to a power receiving unit 103. According to an exemplary embodiment, the power receiving unit 103 includes a grid tied commercial power inverter or micro inverter. The ratiometric DC to DC converter circuit shown in FIG. 1 is also referred to herein as a ratiometric voltage boost circuit since in many instances it is used to boost (increase) the voltage coming out of the array of photovoltaic power producing elements.

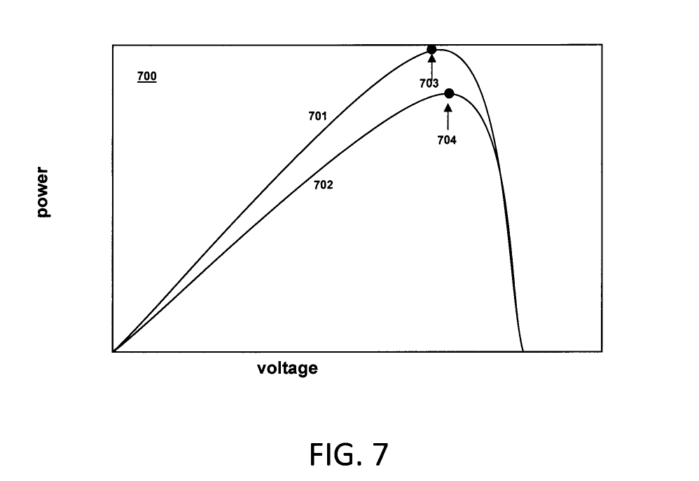

It is important to the operation of a grid connected array of photovoltaic cells that the operating current and voltage be optimized to the maximum power point. This is achieved by the maximum power point tracker (MPPT). By way of example only, some maximum power point tracker circuits function (i.e., “track” the maximum power point which may be constantly changing) by sampling the output of the photovoltaic power producing elements and applying an amount of impedance sufficient to obtain maximum power output from the photovoltaic power producing elements. See also description of FIG. 7, below. Thus, the MPPT sets the current that the power receiving unit should receive from the photovoltaic power producing elements in order to obtain the maximum power. Maximum power point trackers are described, for example, in Zhang et al., “Research on MPPT control and implementation method for photovoltaic generation system and its simulation,” 6^{th} International Power Electronics and Motion Control Conference, 2009 (IPEMC '09), pgs. 2108-2112, May 17-20 (2009), the contents of which are incorporated by reference herein.

In one exemplary embodiment, the maximum power point tracker (MPPT) is a single unit (computer-driven circuit configured to, e.g., based on the output of the photovoltaic power producing elements apply an amount of impedance sufficient to obtain maximum power output from the photovoltaic power producing elements) that outputs a fixed DC voltage. The output(s) of the MPPT unit(s) is/are connected to the DC to AC inverter. The inverter in a photovoltaic system, as is known in the art, is used to convert the DC output of the photovoltaic power producing elements into alternating current that can be fed into the grid. Photovoltaic inverters are commercially available, for example, from SMA Solar Technology, Rocklin, Calif. and Enphase Energy Corporation, Petaluma, Calif.

In another exemplary embodiment the function of the MPPT is combined with the grid tied DC to AC inverter in a single unit. Low power versions of this system are sometimes referred to as micro inverters (e.g., micro inverters are typically rated at 200 W to 400 W). Micro inverters are commercially available, for example, from Direct Grid® Technologies, Edgewood, N.J.

It is notable that while the power receiving unit in the embodiments shown and described herein includes a grid tied DC to AC inverter (and potentially a maximum power point tracker (MPPT)) this is merely one exemplary configuration. Namely, the power receiving unit can be any device that either passes the power on or uses the power itself. By way of example only, the power receiving unit might include a device, such as a battery, or electric motor that can use the DC power directly. In that case, no inverter is necessary.

Concentrator photovoltaic cells utilize lenses and/or mirrors to concentrate incident solar power onto a photovoltaic cell(s). Concentrator photovoltaic cells are described, for example, in Luque, Antonio; Hegedus, eds (2003). “Handbook of Photovoltaic Science and Engineering.” John Wiley and Sons. ISBN 0471491969, the contents of which are incorporated by reference herein.

By employing a ratiometric DC to DC converter (such as in the circuit of FIG. 1, and those described below), the ratiometric DC to DC converter can serve to increase/boost the output voltage from the array. This is useful in that an array of photovoltaic power producing elements in a panel or string may produce a voltage that does not match the input requirements of a particular MPPT tracker/inverter or other power receiving device. In this case the circuits shown in FIGS. 1-3 can be used to match the voltage of the photovoltaic power producing elements to the input requirements of the MPPT tracker/inverter.

The power receiving unit 103 is further connected to an AC power grid via connection 104. By way of example only, connection 104 is a wired connection to the power grid. Alternatively, the power receiving unit may be connected (via connection 104) to a device that runs on AC power (such as a machine or appliance) or to a connector (e.g., outlet) to which a device that runs on AC power can be connected. Further, as shown in FIG. 1, diodes 108 are employed in the circuit. It is notable that the protection diodes shown in FIG. 1 (and in other embodiments involving serial connections, described herein) as well as the fuses being shown in one or more embodiments described herein involving parallel connections are optional and do not affect the general operation of the present techniques. As is apparent from FIG. 1, the use of diodes 108 (or fuses in the case of parallel connected power producing elements, see below) ensures that current can flow even if one or more of the photovoltaic power producing elements 101 ceases functioning. Further, while FIG. 1 shows a diode across each power producing element, this configuration is merely exemplary. For instance, in some embodiments a single diode/fuse may be used to bridge multiple power producing elements in a group in order to save cost. This means that if a single diode/fuse in the group fails, the entire group is lost. The number and placement of bypass diodes/fuses is a system reliability and economic choice. The bypass diodes/fuses are shown in FIGS. 1-4 for completeness, but as highlighted above are not required.

It is notable, however, that the ratiometric DC to DC converters described herein may also be employed to lower the voltage output (also referred to as bucking which is the opposite of boosting) from an array of photovoltaic power producing elements. The ratiometric DC to DC converters add the additional capability to regulate the input/output voltage ratio. Therefore, the ratiometric DC to DC converters described herein are configured to alter, i.e., increase (boost) and/or decrease (buck), the voltage output from the array depending, e.g., on the input voltage requirements of the power receiving element. Further, as provided above, and as is apparent from FIG. 1, the use of diodes 108 ensures that current can flow even if one or more of the photovoltaic power producing elements 101 ceases functioning.

The input and output stages of the ratiometric DC to DC converter 105 are electrically isolated. In some embodiments this allows the possibility to physically localize high voltage elements of a solar panel to reduce costs.

In one exemplary embodiment, such as that shown in FIG. 1, an output of the ratiometric DC to DC converter 105 is directly connected to a power receiving unit 103. As above, the power receiving element can be a combined MPPT/DC to AC inverter such as a micro inverter. According to an exemplary embodiment, the MPPT is combined with the DC to AC inverter and the MPPT directly converts the input to AC. In another exemplary embodiment (such as that shown in FIG. 2, described below) the output of the ratiometric DC to DC converter is connected in series to the photovoltaic power producing elements and the power receiving element.

According to an exemplary embodiment, the maximum power point tracker (MPPT) circuit is a computer driven circuit that varies the input impedance to the ratiometric DC to DC converter with a fixed voltage output. The output of the MPPT is connected to the DC to AC inverter that applies the power to the grid. This may be done in a one to one ratio or multiple systems may be connected in parallel to a large inverter to achieve higher efficiency or lower cost.

The circuit shown in FIG. 1 is used to modify the voltage applied to the power receiving element 103 according to the fixed voltage ratio of the ratiometric DC to DC converter 105. As highlighted above, a ratiometric DC to DC converter imposes a fixed voltage ratio between its input and output. Namely, the voltage output of the ratiometric DC to DC converter is a ratio of the voltage into the ratiometric DC to DC converter. Typical (input/output) voltage ratios from commercially available ratiometric DC to DC converters range from about 1:1 to about 1:16. The voltage output of the circuit measured at the input of the power receiving element 103 can be computed as:

Vcells+Vcells*R,

wherein R is the voltage ratio of the ratiometric DC to DC converter. Vcells is the voltage produced by the array of photovoltaic cells. By way of example only, a ratiometric DC to DC converter with a (input/output) voltage ratio of 1:2 will have an R value of 2. The current produced by the array of photovoltaic cells will be inversely reduced. The benefit of the circuit shown in FIG. 1 is twofold. First, the use of the ratiometric DC to DC converter with the series connected photovoltaic power producing elements (as in FIG. 1) allows a system to be constructed in which the voltage of the series of photovoltaic cells is matched (increased or decreased) to the acceptable input voltage range of the power receiving element 103.

Second, a further benefit of the circuit of FIG. 1 is that power point tracking ability of the power receiving element 103 is assured by virtue of the ratiometric property of the ratiometric DC to DC converter (i.e., the circuit output varies proportionally to the cell output). This is a requirement in grid connected photovoltaic systems where maximum power point tracking is needed to assure optimum power transfer.

It is notable that a significant amount of useful power point tracking and power inversion technology is becoming available for the flat panel photovoltaic modules market. It is desirable to be able to utilize this technology in the concentrator photovoltaic sector. Concentrator systems may have different current to voltage ratios than similar size flat panel embodiments. In some concentrator embodiments, use of flat panel technology is facilitated by increasing the voltage to current ratio to more closely match values typical of flat panel photovoltaic modules.

FIG. 2 is a circuit diagram of a photovoltaic system wherein an array of photovoltaic power producing elements 201, such as photovoltaic cells (e.g., concentrator photovoltaic cells), are connected in parallel to the inputs of a ratiometric DC to DC converter 203. The array is further connected in series to a power receiving unit 204. In one exemplary embodiment, the output of the ratiometric DC to DC converter circuit is directly connected to the power receiving unit 204. This configuration is shown illustrated in FIG. 1, described above. In another embodiment (shown in FIG. 2) the output of the ratiometric DC to DC converter 203 is connected in series to the photovoltaic power producing elements 201 and to the power receiving unit 204. According to an exemplary embodiment, the power receiving unit 204 includes a grid tied commercial power inverter or micro inverter.

As shown in FIG. 2, in this example the power receiving unit 204 includes a maximum power point tracker (MPPT) and a grid tied DC to AC inverter. According to an exemplary embodiment, the MPPT is combined with the DC to AC inverter and the MPPT directly converts the input to AC. According to an exemplary embodiment, the maximum power point tracker (MPPT) circuit is a computer driven circuit that varies the input impedance to the ratiometric DC to DC converter with a fixed voltage output. The output of the MPPT is connected to the DC to AC inverter that applies the power to the grid. This may be done in a one to one ratio or multiple systems may be connected in parallel to a large inverter to achieve higher efficiency or lower cost.

The power receiving unit 204 is further connected to an AC power grid via connection 205. By way of example only, connection 205 is a wired connection to the power grid. Alternatively, the power receiving unit may be connected (via connection 205) to a device that runs on AC power (such as a machine or appliance) or to a connector (e.g., outlet) to which a device that runs on AC power can be connected. Further, as shown in FIG. 2, fuses 202 are employed in the circuit to protect the overall circuit by isolating a failed device.

The circuit shown in FIG. 2 inherits the advantages of a parallel-connected circuit and has the further advantage of providing a higher voltage to current ratio to the input of the power receiving unit 204 which might otherwise be too low. The benefits here again are that the circuit allows a system to be constructed in which the voltage of the photovoltaic power producing elements 201 is matched to the acceptable input voltage range of the power receiving element 204.

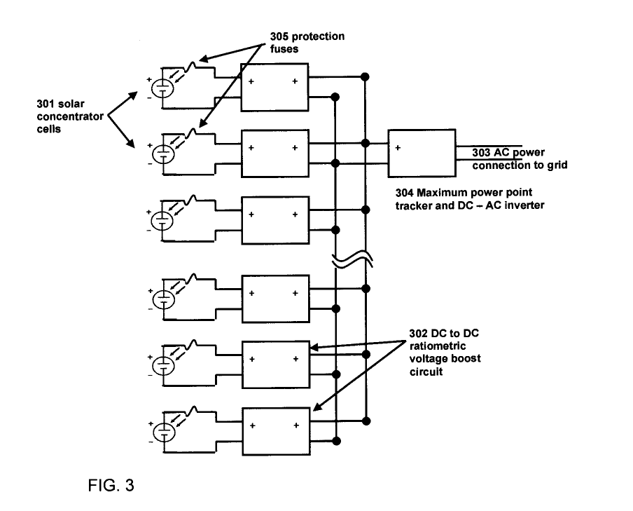

FIG. 3 is a circuit diagram of a photovoltaic system wherein an array of photovoltaic power producing elements 301, such as photovoltaic cells (e.g., concentrator photovoltaic cells) are directly connected to the input of ratiometric DC to DC converters 302 in a one to one relationship. The outputs of the ratiometric DC to DC converters 302 are parallel connected to the input of a power receiving unit 304. According to an exemplary embodiment, the power receiving unit 304 includes a grid tied commercial power inverter or micro inverter.

As shown in FIG. 3, in this example the power receiving unit 304 includes a maximum power point tracker (MPPT) and a grid tied DC to AC inverter. According to an exemplary embodiment, the MPPT is combined with the DC to AC inverter and the MPPT directly converts the input to AC. According to an exemplary embodiment, the maximum power point tracker (MPPT) circuit is a computer driven circuit that varies the input impedance to the ratiometric DC to DC converter with a fixed voltage output. The output of the MPPT is connected to the DC to AC inverter that applies the power to the grid. This may be done in a one to one ratio or multiple systems may be connected in parallel to a large inverter to achieve higher efficiency or lower cost.

The power receiving unit 304 is further connected to an AC power grid via connection 303. By way of example only, connection 303 is a wired connection to the power grid. Alternatively, the power receiving unit may be connected (via connection 303) to a device that runs on AC power (such as a machine or appliance) or to a connector (e.g., outlet) to which a device that runs on AC power can be connected. Further, as shown in FIG. 3, fuses 305 are employed in the circuit to protect the overall circuit by isolating a failed device.

Thus, the circuit shown in FIG. 3 employs multiple ratiometric DC to DC converters (as compared, for example, to the circuit shown in FIG. 2). By way of example only, in one exemplary embodiment, there is one ratiometric DC to DC converter per photovoltaic power producing elements 301. See FIG. 3. In the same manner, instead of employing one ratiometric DC to DC converter for each photovoltaic power producing element 301, one ratiometric DC to DC converter can be used for each of multiple groups of photovoltaic power producing elements. By way of example only, combining the configurations shown in FIGS. 2 and 3, a group of photovoltaic power producing elements may be connected to a ratiometric DC to DC converter as shown in FIG. 2. Multiple groups (each group connected to its own ratiometric DC to DC converter) are then parallel connected to the power receiving unit as shown in FIG. 3. In the simplest case, the groupings are based on cost. For instance, if there are x number of cells, and based on budget and cost per ratiometric DC to DC converter there are y number of ratiometric boost circuits, then the result is x/y number of groupings.

The circuit shown in FIG. 3 inherits the advantages of all the parallel connected circuits described above and further allows flexibility in component selection by utilizing lower current versions of the ratiometric DC to DC converter, since each ratiometric DC to DC converter handles the output of a single photovoltaic power producing element or group of photovoltaic power producing elements, rather than the total array. Lower current versions of the ratiometric DC to DC converter are less costly, which is beneficial.

Each of the circuits shown above in which a ratiometric DC to DC converter is placed in the power path consumes a portion of the power produced by the cells due to the efficiency of conversion. This is typically 95%. In other words, the aforementioned advantages carry the cost of 5% of the power that flows through them.

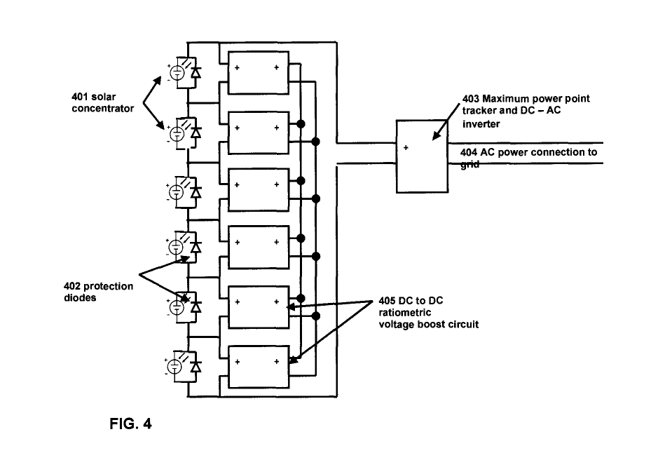

Another exemplary embodiment that addresses this short coming is shown in FIG. 4. FIG. 4 is a circuit diagram of a photovoltaic system wherein a plurality of photovoltaic power producing elements 401, such as photovoltaic cells (e.g., concentrator photovoltaic cells) is connected in series to a power receiving unit 403. According to an exemplary embodiment, the power receiving unit 403 includes a grid tied commercial power inverter or micro inverter. The output of each of the series connected photovoltaic power producing elements 401 is further connected to the inputs of ratiometric DC to DC converters 405 in a one to one relationship.

As shown in FIG. 4, in this example the power receiving unit 403 includes a maximum power point tracker (MPPT) and a grid tied DC to AC inverter. According to an exemplary embodiment, the MPPT is combined with the DC to AC inverter and the MPPT directly converts the input to AC. According to an exemplary embodiment, the maximum power point tracker (MPPT) circuit is a computer driven circuit that varies the input impedance to the ratiometric DC to DC converter with a fixed voltage output. The output of the MPPT is connected to the DC to AC inverter that applies the power to the grid. This may be done in a one to one ratio or multiple systems may be connected in parallel to a large inverter to achieve higher efficiency or lower cost.

The power receiving unit 403 is further connected to an AC power grid via connection 404. By way of example only, connection 404 is a wired connection to the power grid. Alternatively, the power receiving unit may be connected (via connection 404) to a device that runs on AC power (such as a machine or appliance) or to a connector (e.g., outlet) to which a device that runs on AC power can be connected. Further, as shown in FIG. 4, diodes 402 are employed in the circuit. As described above, the use of diodes 402 ensures that current can flow even if one or more of the photovoltaic power producing elements 401 ceases functioning.

The outputs of the ratiometric DC to DC converters 405 are connected in parallel and thus are constrained to a common floating voltage. The terms “float” and “floating voltage” as used herein refer to the concept that the photovoltaic power producing elements in the array are permitted to equilibrate to an average output value (i.e., power will be shunted from over performing photovoltaic power producing elements in the array to under-performing photovoltaic power producing elements in the array to achieve an average output value. By constraining the outputs of the ratiometric DC to DC converters 405 to a common voltage, the individual photovoltaic power producing element voltages are also constrained to a common (average) voltage. Accordingly, an input voltage to the ratiometric DC to DC converters 405 is thus constrained to a common value. In the case where an individual photovoltaic power producing element is underperforming, current is applied from the other photovoltaic power producing elements through the ratiometric DC to DC converters 405 to that underperforming individual photovoltaic power producing element's output. In the case where a photovoltaic power producing element is producing more than the average, its power is shunted to adjacent underperforming photovoltaic power producing elements. Thus power is balanced. Unlike the aforementioned embodiments, the amount of power flowing through the ratiometric DC to DC converters is limited to the difference of a photovoltaic power producing element's power from the average value. This is much smaller than in the aforementioned embodiments where all the photovoltaic power producing elements' power flowed through the ratiometric DC to DC converters (e.g., in this embodiment the amount of power flowing through each of the ratiometric DC to DC converters is only from about 2 percent to about 20 percent that of the power flowing through the ratiometric DC to DC converters in the previously described examples). Thus, the circuit of FIG. 4 has the advantage that the amount of power that flows through the ratiometric DC to DC converters 405 is small and the efficiency of the ratiometric DC to DC converter results in less power loss than in the aforementioned embodiments.

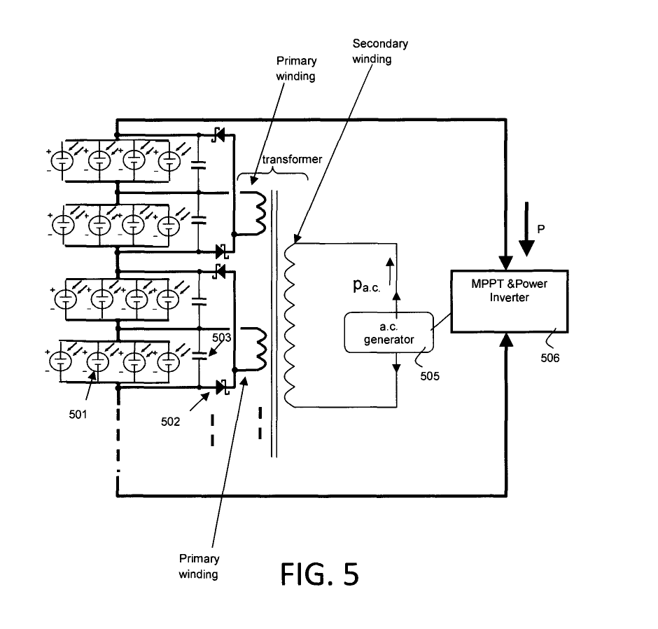

FIG. 5 illustrates a further evolution of the embodiment of FIG. 4. Specifically, FIG. 5 is a circuit diagram of a photovoltaic system in which groups of (in this example groups of four) photovoltaic power producing elements 501, such as photovoltaic cells (e.g., concentrator photovoltaic cells) are connected in parallel and the groups are further connected in series to a power receiving unit 506. According to an exemplary embodiment, the power receiving unit 506 includes a grid tied commercial power inverter or micro inverter.

As shown in FIG. 5, in this example the power receiving unit 506 includes a maximum power point tracker (MPPT) and a DC to AC inverter. According to an exemplary embodiment, the MPPT is combined with the DC to AC inverter and the MPPT directly converts the input to AC. According to an exemplary embodiment, the maximum power point tracker (MPPT) circuit is a computer driven circuit that varies the input impedance to the ratiometric DC to DC converter with a fixed voltage output. The output of the MPPT is connected to the DC to AC inverter. This may be done in a one to one ratio or multiple systems may be connected in parallel to a large inverter to achieve higher efficiency or lower cost.

As shown in FIG. 5, the individual groups of photovoltaic power producing elements 501 are connected to a ratiometric conversion circuit (a ratiometric leveling circuit) comprising discrete circuit components. The ratiometric conversion circuit in this example includes a transformer and other discrete circuit components. As is known in the art, a transformer transfers power from one circuit to another through inductively coupled conductors or coils. These coils are often called primary and secondary windings. As shown in FIG. 5, the transformer can contain multiple, e.g., primary windings, each of the primary windings acting as an AC ratiometric circuit with the secondary winding. When combined with other circuit elements, DC to DC ratiometric conversion is realized. Thus, this has the same effect as in the circuit shown in FIG. 4 of employing multiple ratiometric DC to DC converters in a one to one relationship with the power producing elements (or groupings of the power producing elements). Further, in this configuration, the outputs of the ratiometric conversion circuit are coupled so as to constrain an input voltage of the ratiometric conversion circuit to a common value.

In the circuit configuration shown in FIG. 5, an oscillator 505 (e.g., a programmable AC driver) is employed to excite the transformer. The oscillator shown in FIG. 5 may be set to a particular frequency and amplitude. This results in similar operation to the circuit shown in FIG. 4, i.e., the oscillator 505 can supply power to the power grid. Alternately, the oscillator of the ratiometric conversion circuit may be driven by the maximum power tracking circuit to provide leveled DC power to the inverter.

In this exemplary embodiment shown in FIG. 5, cost savings is realized by the replacement of complicated integrated circuits with simple discrete circuit elements and the grouping of cells in parallel. In the circuit shown in FIG. 5, the individual photovoltaic power producing element 501 groups are connected to the multi tap transformer through Schottky diodes 502. Capacitors 503 are shown across the photovoltaic power producing elements to reduce ripple in the circuit. The transformer is excited with a programmable AC driver (oscillator) 505 that (as described above) may be directed by the MPPT tracker system or constrained to a fixed frequency and amplitude. The circuit shown performs photovoltaic power producing element balancing in the same manner as in the circuit shown in FIG. 4 but illustrates a more economical embodiment.

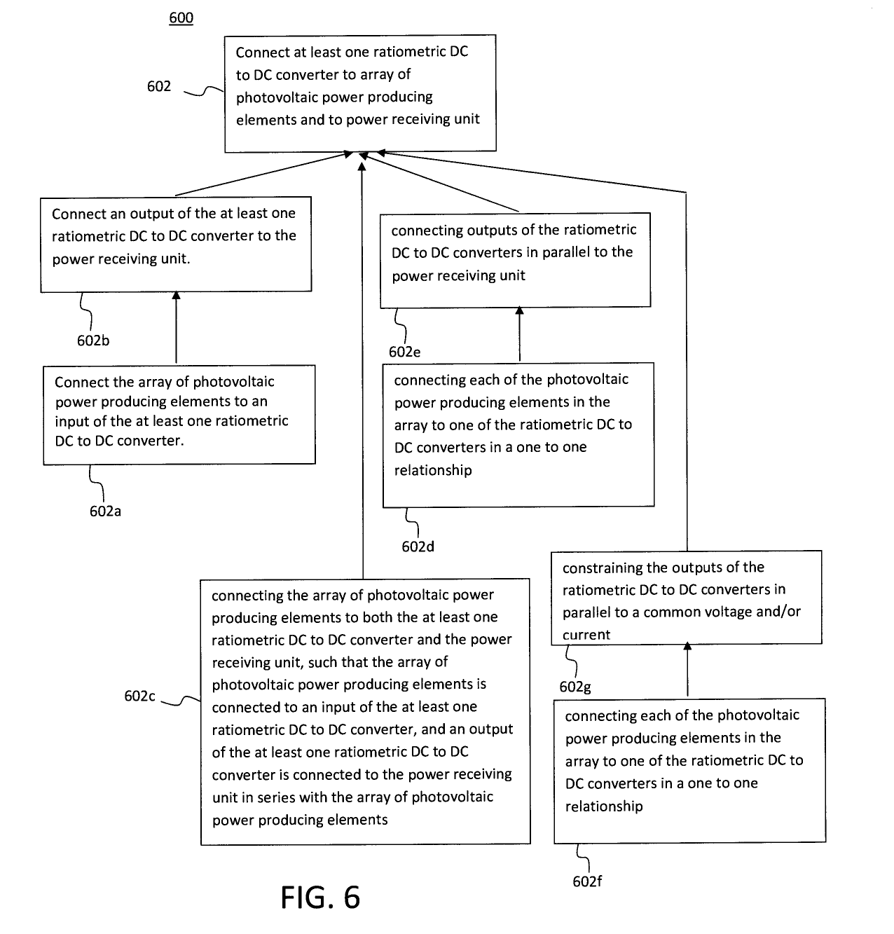

Based on the exemplary embodiments described above, FIG. 6 is a diagram illustrating an exemplary methodology 600 for transferring electrical power from an array of photovoltaic power producing elements to a power receiving unit. As described above, the array of photovoltaic power producing elements includes a plurality of the photovoltaic power producing elements connected either in series or in parallel. As also described above, the power receiving unit can include a DC to AC inverter connected to a maximum power point tracker (MPPT) circuit. This MPPT/inverter configuration was described in detail above.

In step 602, at least one ratiometric DC to DC converter is connected to both the array of photovoltaic power producing elements and the power receiving unit. The ratiometric DC to DC converter(s) is/are configured to alter (increase/decrease) a voltage output from the array of photovoltaic power producing elements. See description above. As shown in FIG. 6, step 602 can be performed in any one of a number of different ways.

By way of example only, step 602 can be performed by connecting the array of photovoltaic power producing elements to an input of the at least one ratiometric DC to DC converter (step 602a); and connecting an output of the at least one ratiometric DC to DC converter to the power receiving unit (step 602b). This is in accordance, for example, with the exemplary system configuration shown in FIG. 1, described above.

Alternatively, step 602 can be performed by connecting the array of photovoltaic power producing elements to both the at least one ratiometric DC to DC converter and the power receiving unit, such that the array of photovoltaic power producing elements is connected to an input of the at least one ratiometric DC to DC converter, and an output of the at least one ratiometric DC to DC converter is connected to the power receiving unit in series with the array of photovoltaic power producing elements (step 602c). This is in accordance, for example, with the exemplary system configuration shown in FIG. 2, described above.

Alternatively, as described above, multiple ratiometric DC to DC converters may be employed. In this case, step 602 can be performed by connecting each of the photovoltaic power producing elements in the array to one of the ratiometric DC to DC converters in a one to one relationship (step 602d); and connecting outputs of the ratiometric DC to DC converters in parallel to the power receiving unit (step 602e). This is in accordance, for example, with the exemplary system configurations shown in FIG. 3 described above.

Alternatively, as described above, multiple ratiometric DC to DC converters may be employed. In this case, step 602 can be performed by connecting each of the photovoltaic power producing elements in the array to one of the ratiometric DC to DC converters in a one to one relationship (step 602f); and connecting outputs of the ratiometric DC to DC converters in parallel or otherwise constraining the outputs to a common voltage and/or current (step 602g). This is in accordance, for example, with the exemplary system configurations shown in FIGS. 4 and 5 described above.

As provided above, the maximum power point tracker (MPPT) (as used herein) adjusts its input impedance to allow series/parallel connected photovoltaic cells to operate at the voltage and current that produces the maximum power transfer. This can be better understood by way of reference to FIG. 7. FIG. 7 is a graph 700 that illustrates power output versus voltage performance for two photovoltaic elements. Specifically, graph 700 shows a power versus voltage curve for two photovoltaic devices 701 and 702 under sun. As can be seen in FIG. 7, there is a voltage where the power is at a maximum (i.e., a maximum power point) (points 703 and 704 respectively). The maximum power point tracker locates the maximum power point and maintains the input impedance at the maximum power point voltage.

With the present techniques a very significant improvement in system efficiency can be realized. By way of example only, employing any one of the above-described configurations can result in at least a 10% improvement in system efficiency with approximately 1% loss due to the DC to DC converter power consumption. The resulting net benefit is thus 9%, which represents a significant savings.

Although illustrative embodiments of the present invention have been described herein, it is to be understood that the invention is not limited to those precise embodiments, and that various other changes and modifications may be made by one skilled in the art without departing from the scope of the invention.

What is claimed is:

1. A photovoltaic system, comprising:
an array of photovoltaic power producing elements;
a power receiving unit; and
at least one ratiometric DC to DC converter connected to both the array of photovoltaic power producing elements and the power receiving unit, wherein the at least one ratiometric DC to DC converter is configured to alter a voltage output from the array of photovoltaic power producing elements supplied to the power receiving unit.

2. The photovoltaic system of claim 1, wherein the photovoltaic power producing elements comprise concentrator photovoltaic cells.

3. The photovoltaic system of claim 1, wherein the power receiving unit comprises a maximum power point tracker (MPPT) circuit.

4. The photovoltaic system of claim 3, wherein the power receiving unit comprises a DC to AC inverter connected to the maximum power point tracker (MPPT) circuit.

5. The photovoltaic system of claim 1, wherein the array of photovoltaic power producing elements comprises a plurality of the photovoltaic power producing elements connected in series.

6. The photovoltaic system of claim 1, wherein the array of photovoltaic power producing elements comprises a plurality of the photovoltaic power producing elements connected in parallel.

7. The photovoltaic system of claim 1, wherein the array of photovoltaic power producing elements is connected to an input of the at least one ratiometric DC to DC converter, and wherein an output of the at least one ratiometric DC to DC converter is connected to the power receiving unit.

8. The photovoltaic system of claim 1, wherein the array of photovoltaic power producing elements is connected to both the at least one ratiometric DC to DC converter and the power receiving unit, such that the array of photovoltaic power producing elements is connected to an input of the at least one ratiometric DC to DC converter, and an output of the at least one ratiometric DC to DC converter is connected to the power receiving unit in series with the array of photovoltaic power producing elements.

9. The photovoltaic system of claim 1, comprising a plurality of the ratiometric DC to DC converters, wherein each of the photovoltaic power producing elements in the array is connected to one of the ratiometric DC to DC converters in a one to one relationship, and wherein outputs of the ratiometric DC to DC converters are connected in parallel to the power receiving unit.

10. The photovoltaic system of claim 1, comprising a plurality of the ratiometric DC to DC converters, wherein each of the photovoltaic power producing elements in the array is connected to one of the ratiometric DC to DC converters in a one to one relationship, and wherein outputs of the ratiometric DC to DC converters are connected in parallel so as to constrain an input voltage of the ratiometric DC to DC converters to a common value.

11. The photovoltaic system of claim 1, comprising a plurality of the ratiometric DC to DC converters, wherein each of the photovoltaic power producing elements in the array is connected to one of the ratiometric DC to DC converters in a one to one relationship, and wherein outputs of the ratiometric DC to DC converters are coupled so as to constrain an input voltage of said ratiometric DC to DC converters to a common value.

12. The photovoltaic system of claim 1, wherein the power receiving unit is connected to a power grid.

13. A method of transferring electrical power from an array of photovoltaic power producing elements to a power receiving unit, the method comprising the step of:
connecting at least one ratiometric DC to DC converter to both the array of photovoltaic power producing elements and the power receiving unit, wherein the at least one ratiometric DC to DC converter is configured to alter a voltage output from the array of photovoltaic power producing elements supplied to the power receiving unit.

14. The method of claim 13, wherein the at least one ratiometric DC to DC converter is configured to either increase or decrease the voltage output from the array of photovoltaic power producing elements.

15. The method of claim 13, wherein the power receiving unit comprises a maximum power point tracker (MPPT) circuit.

16. The method of claim 15, wherein the power receiving unit comprises a DC to AC inverter connected to the maximum power point tracker (MPPT) circuit.

17. The method of claim 13, wherein the array of photovoltaic power producing elements comprises a plurality of the photovoltaic power producing elements connected in series.

18. The method of claim 13, wherein the array of photovoltaic power producing elements comprises a plurality of the photovoltaic power producing elements connected in parallel.

19. The method of claim 13, further comprising the steps of:
connecting the array of photovoltaic power producing elements to an input of the at least one ratiometric DC to DC converter; and connecting an output of the at least one ratiometric DC to DC converter to the power receiving unit.

20. The method of claim 13, further comprising the step of:
connecting the array of photovoltaic power producing elements to both the at least one ratiometric DC to DC converter and the power receiving unit, such that the array of photovoltaic power producing elements is connected to an input of the at least one ratiometric DC to DC converter, and an output of the at least one ratiometric DC to DC converter is connected to the power receiving unit in series with the array of photovoltaic power producing elements.

21. The method of claim 13, wherein a plurality of the ratiometric DC to DC converters is employed, the method further comprising the steps of:
connecting each of the photovoltaic power producing elements in the array to one of the ratiometric DC to DC converters in a one to one relationship; and
connecting outputs of the ratiometric DC to DC converters in parallel to the power receiving unit.

22. The method of claim 13, wherein the power receiving unit is connected to a power grid.
